(19) United States
(12) Patent Application Publication
(10) Pub. No.: US 2026/0217372 A1
(43) Pub. Date: Jul. 30, 2026

(54) ARMREST SYSTEM

(71) Applicant: Tusas- Turk Havacilik Ve Uzay Sanayii Anonim Sirketi, Kahramankazan, Ankara (TR)

(72) Inventors: Fatma Cagla DAG KILIC, Kahramankazan, Ankara (TR); Aydemir KUCUK, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/143,483

(22) PCT Filed: Nov. 15, 2023
(86) PCT No.: PCT/TR2023/051336

§ 371 Date: Jun. 26, 2025

(30) Foreign Application Priority Data
Dec. 29, 2022 (TR) 2022/021130

(51) Int. Cl. B64D 11/06

(52) U.S. Cl. CPC B64D 11/0644; B64D 11/0689

(57) ABSTRACT

The present invention relates to at least one body (B) on an air vehicle; a joystick (J) located on the body (B) and used by the pilot to steer the air vehicle; at least one armrest (K) at the air vehicle, on which the pilot places his arm to use the joystick (J) ergonomically; at least one shaft (2) which allows the armrest (K) to be adjusted at a height determined by the pilot, and on which the armrest (K) is fitted at least one auxiliary rod (201) located on the shaft (2) in a fixed manner; at least one main rod (202) located on the shaft (2) between the armrest (K) and the auxiliary rod (201), with the capability of moving linearly on the auxiliary rod (201); at least one absorber (3) located on the auxiliary rod (201), thereby absorbing movement of the armrest (K) during the movement of the main rod (202) on the auxiliary rod (201); at least one latch (4) triggered by the pilot to allow the movement of the main rod (202) on the auxiliary rod (201).

This invention relates to an armrest system used in an air vehicle.

Armrest is an element where pilots position their arms while using a joystick in air and/or space vehicles. The armrest is used by the pilot to use the joystick in an ergonomic manner to provide control input to the air and/or space vehicle, to prevent the pilot from transferring uncontrolled power or not being able to transfer the required power in case of exhaustion. The mechanism by which pilots control the air vehicle is divided into two, depending on the placement position: center stick and side stick. Side stick is preferred in jet aircraft with high maneuverability. When using the side stick, an armrest is used to improve flight by stabilizing the pilot's arm, and also to reduce wrist and arm fatigue. The pilot places his arm on the armrest to provide more comfortable and precise force transfer while providing input to the joystick, without having to bear the weight of his arm, especially during long flight periods, thereby providing a more precise force transfer to the joystick.

US20070228797, which is included in the known-state of the art, discloses a telescopic support for an armrest of a chair. The telescopic support comprises a lower tube, an upper tube and a helical spring. The lower tube is installed on the chair.

U.S. Pat. No. 5,884,975, which is included in the known-state of the art, discloses a chair armrest comprising a vertical adjuster and an angle adjuster combined with the vertical adjuster so as to suit to different body size of different users.

Thanks to an armrest system according to the present invention, a locking process is provided in which the pilot can perform height adjustment more effectively with one hand.

Another object of the invention is to provide an armrest with weight gain to be used in jet aircraft.

The armrest system realized to achieve the object of the invention, which is defined in the first claim and other claims dependent thereon, comprises at least one body of an air vehicle, which is a cockpit area. There is a joystick inside the body for the pilot to steer the air vehicle. There is at least one armrest inside the body, on which the pilot can place his arm to use the joystick comfortably. The armrest is adjusted by changing a height of a shaft on which the armrest is located. At least one auxiliary rod is fixed on the shaft. Between the armrest and the auxiliary rod, it moves linearly on the auxiliary rod along the direction it extends with the main rod on the shaft. The linear movement of the main rod on the auxiliary rod is carried out by means of a latch. At least one absorber in the form of a spring is located between the main rod and the auxiliary rod, and absorbs the linear movement of the main rod on the auxiliary rod.

The armrest system according to the invention comprises at least one slot forming a recess on the auxiliary rod. There is at least a first gear in gear form, which is located in connection with the latch so as to be triggered by the movement of the latch. There is at least a second gear located in contact with the first gear, activated by a trigger of the first gear, and located in gear form in contact with the first gear. The second gear is located concentrically with a transmission element and surrounds the transmission element all around. The locking element is located on the transmission element. When the pilot pulls the latch towards himself, the transmission element rotates around its own axis, so that the locking element rotates and fits into the slot.

In an embodiment of the invention, the armrest system comprises a first case in which the pilot pulls the latch towards itself such that the transmission element is triggered to rotate around its own axis and the locking element moves out of the slot. It comprises a second case in which the pilot releases the latch such that the transmission element rotates in a opposite direction compared to the first case and the locking element is inserted into the slot.

In an embodiment of the invention, the armrest system is produced with a plurality of slots on the auxiliary rod, at intervals determined by the manufacturer. It comprises a first position in which the locking element, which is moved to the first case by the pilot pulling the latch towards himself, fits into any of the slots determined by the pilot with the pilot's arm weight. There is a second position in which the armrest is released by the effect of the absorber when the pilot releases the latch and lifts the arm weight from the armrest.

In an embodiment of the invention, the armrest system comprises two shafts located mirror symmetrically and opposite with respect to the latch on the armrest. The latch is located almost in the middle of the armrest. There are locking elements on both shafts, one of which rotates clockwise and the other counterclockwise when the pilot triggers the latch.

In an embodiment of the invention, the armrest system comprises at least one protrusion between both shafts extending outward from the armrest, wherein the latch is provided on the protrusion. The first gear is located on the latch in the form of a rack gear. The second gear is in contact with the first gear, and provided as a pinion gear.

In an embodiment of the invention, the armrest system comprises at least one groove that creates an opening on the protrusion and allows the latch to move towards and/or away from the armrest via the pilot. It comprises at least one intermediate element connected to the first gear and transferring the movement of the latch in the groove to the first gear. It comprises at least one flexible element on the intermediate element, which acts as a spring and absorbs the linear movement of the latch in the groove.

In an embodiment of the invention, in the armrest system, the auxiliary rod is located on a ground. The absorber is located on the auxiliary rod, so as to be connected to the main rod. As the absorber approaches the ground on the auxiliary rod of the main rod, it is compressed between the main rod and the ground.

In an embodiment of the invention, the armrest system comprises at least one channel forming an opening along the main rod. It comprises at least one pin located in the channel to make a linear movement and extending outward from the auxiliary rod towards the channel.

In an embodiment of the invention, the armrest system comprises at least one guide located on the main rod and moving linearly on the auxiliary rod together with the fixed rod.

In an embodiment of the invention, the armrest system comprises the latch positioned between the armrest and the joystick.

In an embodiment of the invention, the armrest system comprises the ground, which is a console on the body, where the interface parts are located. The armrest is connected to the console without the need for an external fastener.

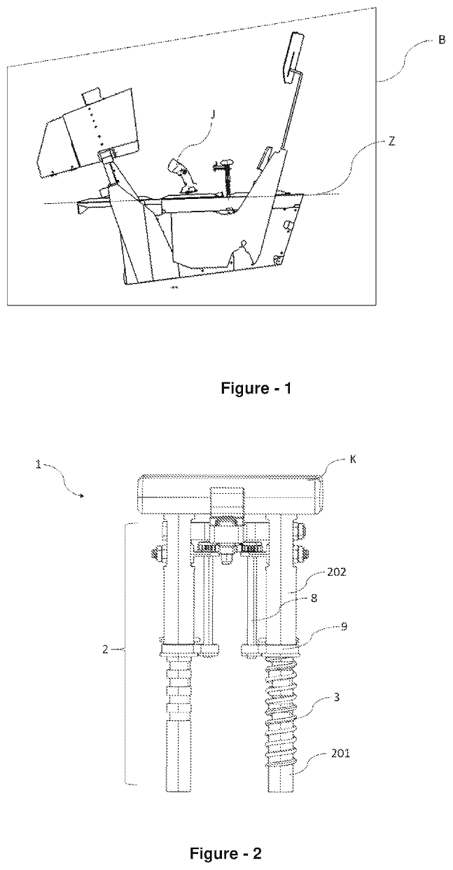

The armrest system realized to achieve the object of the present invention is illustrated in the attached drawings, in which:
FIG. 1 is a schematic view of the body and ground.

FIG. 2 is a schematic view of the armrest system and the second position (II).

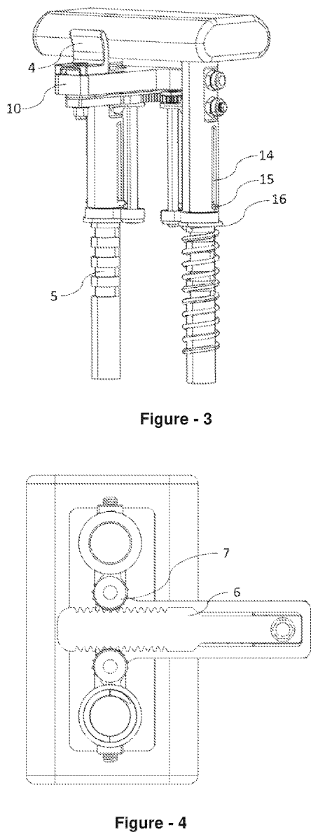

FIG. 3 is a schematic view of the latch, protrusion, recess, channel, pin and guide.

FIG. 4 is a top-schematic view of the first gear and second gear.

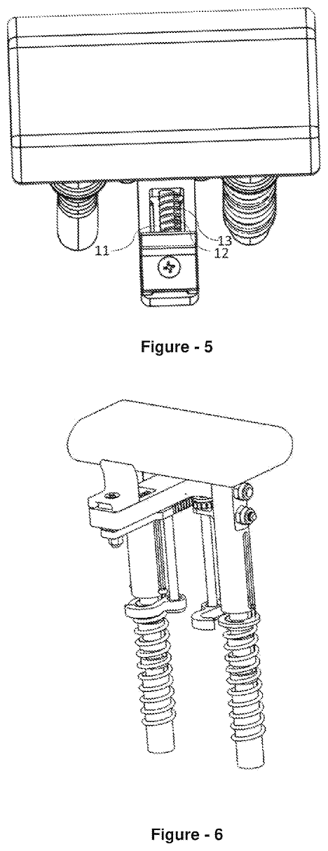

FIG. 5 is a schematic view of the groove, flexible element and intermediate element.

FIG. 6 is a schematic view of the first case (I).

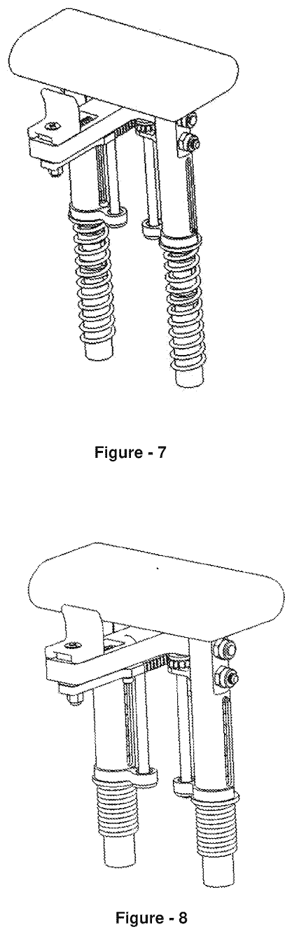

FIG. 7 is a schematic view of the second case (II).

FIG. 8 is a schematic view of the first position (I).

All the parts illustrated in figures are individually assigned a reference numeral and the corresponding terms of these numbers are listed below:
1. Armrest system
2. Shaft
201. Auxiliary rod
202. Main rod
3. Absorber
4. Latch
5. Slot
6. First gear
7. Second gear
8. Transmission element
9. Locking element
10. Protrusion
11. Groove
12. Intermediate element
13. Flexible element
14. Channel
15. Pin
16. Guide
B. Body
J. Joystick
K. Armrest
Z. Ground It comprises at least one body (B) on an air vehicle; a joystick (J) located on the body (B) and used by the pilot to steer the air vehicle; at least one armrest (K) at the air vehicle, on which the pilot places his arm to use the joystick (J) ergonomically; at least one shaft (2) which allows the armrest (K) to be adjusted at a height determined by the pilot, and on which the armrest (K) is fitted; at least one auxiliary rod (201) located on the shaft (2) in a fixed manner; at least one main rod (202) located on the shaft (2) between the armrest (K) and the auxiliary rod (201), with the capability of moving linearly on the auxiliary rod (201); at least one absorber (3) located on the auxiliary rod (201), thereby absorbing movement of the armrest (K) during the movement of the main rod (202) on the auxiliary rod (201); at least one latch (4) triggered by the pilot to allow the movement of the main rod (202) on the auxiliary rod (201).

The armrest system (1) according to the invention comprises at least one slot (5) located on the auxiliary rod (201) and forming a recess; at least a first gear (6) located as a gear on the latch (4); at least a second gear (7) on the first gear (6), which is triggered when the first gear (6) is triggered by the latch (4); at least one transmission element (8) which moves with the main rod (202), and on which the second gear (7) is located; at least one locking element (9) located on the transmission element (8), wherein the transmission element (8) rotates around its own axis when the pilot triggers the latch (4), so that the locking element (9) is fitted into the slot (5).

Inside the body (B) of an air vehicle, the joystick (J) is provided for the pilot to steer the air vehicle. There is an armrest (K) placed under the pilot's arm to use the joystick (J) comfortably. The most important need for the pilot when using the side stick (J) is the height adjustment, which is carried out by the shaft (2) located under the armrest (K). Since the main rod (202) on the shaft (2) performs a downward and/or upward movement on the auxiliary rod (201), the height of the armrest (K) can be adjusted depending on the pilot's preferences. The absorber (3) absorbs the movement of the main rod (202) on the auxiliary rod (201). The movement of the main rod (202) on the auxiliary rod (201) occurs by triggering the latch (4).

At least one slot (5) is provided on the auxiliary rod (201), which forms a recess. There is at least a first gear (6), which is located in connection with the latch (4) and triggered by triggering the latch (4). A second gear (7) is triggered by the linear movement of the first gear (6) and rotates with the linear movement of the first gear (6). The second gear (7) is located around the transmission element (8), so as to be concentric with the transmission element (8). The transmission element (8) rotates with the rotational movement of the second gear (7), and enables the locking element (9), which is provided thereon in the form of a hook, to be fitted into the slot (5), thereby enabling the armrest (K) to be locked and adjusted in height (FIG. 1, FIG. 7).

In an embodiment of the invention, the armrest system (1) comprises a first case (I) in which the transmission element (8) rotates around its own axis and the locking element (9) moves away from the slot (5) when the pilot triggers the latch (4); a second case (II) in which the transmission element (8) rotates around its own axis and the locking element (9) is inserted into slot (5) when the pilot releases the latch (4). In the second case (II), when the pilot stops holding the latch (4), the locking element (9) is inserted into the slot (5) (FIG. 5, FIG. 6).

In an embodiment of the invention, the armrest system (1) comprises a plurality of slots (5) located on the auxiliary rod (201) at intervals determined by the manufacturer; a first position (I) in which the locking element (9), which has moved to the first case (I) by the pilot triggering the latch (4), is inserted into one of the slots (5) determined by the pilot with the pilot's arm weight; a second position (II) in which the armrest (K) is released by the effect of the absorber (3) when the pilot releases the latch (4). A plurality of slots (5) are provided on the auxiliary rod (201) at certain predetermined intervals. In this way, the pilot can place his arm on the armrest (K) and lower the armrest (K) with the weight of his arm, so that the armrest (K) is at any desired height. The pilot enables the locking element (9) to be inserted into the slot (5) located at the desired height of the armrest (K). When the pilot releases the latch (4) and pulls the arm weight from the armrest (K), the absorber (3) enables the main rod (202) to return to its highest position.

In an embodiment of the invention, the armrest system (1) comprises two shafts (2), which are located symmetrically and opposite on the armrest (K) with respect to the latch (4), thus allowing the load of the pilot arm to be distributed; the locking element (9) located on both shafts (2) to move simultaneously in an opposite direction relative to each other when triggered by the latch (4). The latch (4) is located almost in the middle of the armrest (K). Two shafts (2) are located on both sides of the latch (4), so that the load of the pilot's arm weight is distributed evenly on the ground.

In an embodiment of the invention, the armrest system (1) comprises at least one protrusion (10) located between the shafts (2) and extending outward from the armrest (K), wherein the latch (4) is located on the protrusion (10); the latch (4) located on the protrusion (10); the first gear (6) provided as a rack gear in connection with the latch (4); the second gear (7) provided as a pinion gear in connection with the first gear (6). The latch (4) is located on a protrusion (10) between the shafts (2). The latch (4) is located in connection with the first gear (6), which is in the form of a rack gear. When the pilot triggers the latch (4), the first gear (6) is triggered. Linear movement of the first gear (6) triggers the second gear (7), e.g. a pinion gear, thereby converting the linear movement into rotational movement (FIG. 2, FIG. 3).

In an embodiment of the invention, the armrest system (1) comprises at least one groove (11) located on the protrusion (10) and allowing the latch (4) to be moved towards and/or away from the armrest (K) by the pilot; at least one intermediate element (12) located in connection with the first gear (6) and allowing the latch (4) to move longitudinally in the groove (11); at least one flexible element (13) located on the intermediate element (12) and absorbing the movement of the latch (4) in the groove (11). The protrusion (10) extends outward from the armrest (K). The latch (4) can move linearly in a groove (11) so that the pilot can pull the latch (4) towards himself. There is at least one intermediate element (12) in the form of a rod, which is located in the groove (11) in connection with the first gear (6) and transmits the movement of the latch (4) in the groove (11) to the first gear (6). The flexible element (13) located on the intermediate element (12) enables the pilot to move the latch (4) back, when he releases the latch (FIG. 4).

In an embodiment of the invention, the armrest system (1) comprises a ground (Z) on which the auxiliary rod (201) is located; the absorber (3) which is located on the auxiliary rod (201) in connection with the main rod (202), so as to be compressed between the main rod (202) and the ground (Z) during the movement of the main rod (202) on the auxiliary rod (201). The auxiliary rod (201) is located on a ground (Z). The absorber (3) is connected to the main rod (202) and is located on the auxiliary rod (201). The absorber (3) is compressed during the downward movement of the main rod (202) on the auxiliary rod (201) with the pilot's arm weight. Therefore, when the weight of the arm is removed from the armrest (K), the armrest (K) returns to its previous position.

In an embodiment of the invention, the armrest system (1) comprises at least one channel (14) located to form an opening on the main rod (202); at least one pin (15) located in the channel (14) and extending outwards from the auxiliary rod (201), thus preventing the main rod (202) and the auxiliary rod (201) from disengaging from each other. In order to prevent the main rod (202) and the auxiliary rod (201) from disengaging from each other during upwards and downwards movement of the main rod on the latter, a pin (15) located on the auxiliary rod (201) moves linearly within the channel (14) that is provided on the main rod (202).

In an embodiment of the invention, the armrest system (1) comprises at least one guide (16) that at least partially surrounds the slot (5) and enables the locking element (9) to fit almost completely into the slot (5). Thanks to the guide (16), full-insertion of the locking element (9) into the slot (5) is guided. Additionally, the absorber (3) is located on the main rod (202), in connection with the guide (16).

In an embodiment of the invention, the armrest system (1) comprises the latch (4) located between the armrest (K) and the joystick (J), thereby allowing the pilot to adjust the length of the armrest (K) with his arm weight. The pilot's need to adjust the most appropriate armrest position using one hand is provided by the latch (4) located between the armrest (K) and the joystick (J).

In an embodiment of the invention, the armrest system (1) comprises the ground (Z) on the body (B), on which the interface parts are located; the armrest (K) located on the ground (Z). In the cockpit layout, the armrest (K) is generally designed to be mounted on the main structural parts (frame). For this, extra fasteners and brackets are required. In addition, especially in training/jet aircraft with two pilots, different bracket design needs arise because the locations of the main structural parts in the front and rear cockpit are not the same, but the armrest (K) positions must be the same compared to the side stick (J). Weight gain is achieved by directly connecting the armrest (K) to the console where the interface equipment is located.

1. An armrest system (1) comprising at least one body (B) on an air vehicle; a joystick (J) located on the body (B) and used by the pilot to steer the air vehicle; at least one armrest (K) at the air vehicle, on which the pilot places his arm to use the joystick (J) ergonomically; at least one shaft (2) which allows the armrest (K) to be adjusted at a height determined by the pilot, and on which the armrest (K) is fitted; at least one auxiliary rod (201) located on the shaft (2) in a fixed manner; at least one main rod (202) located on the shaft (2) between the armrest (K) and the auxiliary rod (201), with the capability of moving linearly on the auxiliary rod (201); at least one absorber (3) located on the auxiliary rod (201), thereby absorbing movement of the armrest (K) during the movement of the main rod (202) on the auxiliary rod (201); at least one latch (4) triggered by the pilot to allow the movement of the main rod (202) on the auxiliary rod (201), characterized by at least one slot (5) located on the auxiliary rod (201) and forming a recess; at least a first gear (6) located as a gear on the latch (4); at least a second gear (7) on the first gear (6), which is triggered when the first gear (6) is triggered by the latch (4); at least one transmission element (8) which moves with the main rod (202), and on which the second gear (7) is located; at least one locking element (9) located on the transmission element (8), wherein the transmission element (8) rotates around its axis when the pilot triggers the latch (4), so that the locking element (9) is fitted into the slot (5).

2. An armrest system (1) according to claim 1, characterized by a first case (I) in which the transmission element (8) rotates around its axis and the locking element (9) moves away from the slot (5) when the pilot triggers the latch (4); a second case (II) in which the transmission element (8) rotates around its axis and the locking element (9) is inserted into slot (5) when the pilot releases the latch (4).

3. An armrest system (1) according to claim 2, characterized by a plurality of slots (5) located on the auxiliary rod (201) at intervals determined by the manufacturer; a first position (I) in which the locking element (9), which has moved to the first case (I) by the pilot triggering the latch (4), is inserted into one of the slots (5) determined by the pilot with the pilot's arm weight; a second position (II) in which the armrest (K) is released by the effect of the absorber (3) when the pilot releases the latch (4).

4. An armrest system (1) according to any of the above claims, characterized by two shafts (2), which are located symmetrically and opposite on the armrest (K) with respect to the latch (4), thus allowing the load of the pilot arm to be distributed; the locking element (9) located on both shafts (2) to move simultaneously in an opposite direction relative to each other when triggered by the latch (4).

5. An armrest system (1) according to any of the above claims, characterized by at least one protrusion (10) located between the shafts (2) and extending outward from the armrest (K), wherein the latch (4) is located on the protrusion (10); the first gear (6) provided as a rack gear in connection with the latch (4); the second gear (7) provided as a pinion gear in connection with the first gear (6).

6. An armrest system (1) according to claim 5, characterized by at least one groove (11) located on the protrusion (10) and allowing the latch (4) to be moved towards and/or away from the armrest (K) by the pilot; at least one intermediate element (12) located in connection with the first gear (6) and allowing the latch (4) to move longitudinally in the groove (11); at least one flexible element (13) located on the intermediate element (12) and absorbing the movement of the latch (4) in the groove (11).

7. An armrest system (1) according to any of the above claims, characterized by a ground (Z) on which the auxiliary rod (201) is located; the absorber (3) which is located on the auxiliary rod (201) in connection with the main rod (202), so as to be compressed between the main rod (202) and the ground (Z) during the movement of the main rod (202) on the auxiliary rod (201).

8. An armrest system (1) according to any of the above claims, characterized by at least one channel (14) located to form an opening on the main rod (202); at least one pin (15) located in the channel (14) and extending outwards from the auxiliary rod (201), thus preventing the main rod (202) and the auxiliary rod (201) from disengaging from each other.

9. An armrest system (1) according to any of the above claims, characterized by at least one guide (16) that at least partially surrounds the slot (5) and enables the locking element (9) to fit almost completely into the slot (5).

10. An armrest system (1) according to any of the above claims, characterized by the latch (4) located between the armrest (K) and the joystick (J), thereby allowing the pilot to adjust the length of the armrest (K) with his arm weight.

11. An armrest system (1) according to any of the claims 7 to 11, characterized by the ground (Z) on the body (B), on which the interface parts are located; the armrest (K) located on the ground (Z).
